(19) United States
(12) Patent Application Publication
(10) Pub. No.: US 2025/0131373 A1
(43) Pub. Date: Apr. 24, 2025

(54) OPTICAL SENSOR BASED ITEM DETECTION AND LISTING

(71) Applicant: Steals Commerce Inc., Layton, UT (US)

(72) Inventors: SACHIN PAWA, Miami, FL (US); RYAN TREFT, Bountiful, UT (US)

(73) Assignee: Steals Commerce Inc., Layton, UT (US)

(21) Appl. No.: 18/491,751

(22) Filed: Oct. 21, 2023

Related U.S. Application Data
(60) Provisional application No. 63/417,982, filed on Oct. 20, 2022.

(51) Int. Cl. G06Q 10/087; G06K 7/14

(52) U.S. Cl. CPC G06Q 10/087; G06K 7/1408

(57) ABSTRACT

Apparatuses, systems, methods, and computer program products are disclosed for optical sensor based item detection and listing. A method includes processing optical data from an optical sensor to identify an item. A method includes determining data associated with an identified item. A method includes reformatting data to create multiple versions of the data, each of the multiple versions of the data associated with a different listing channel for an identified item.

### CROSS-REFERENCES TO RELATED APPLICATIONS

This application claims the benefit of U.S. Provisional Patent Application No. 63/417,982 entitled “OPTICAL SENSOR BASED ITEM DETECTION AND LISTING” and filed on Oct. 20, 2022, for Sachin Pawa, et al., which is incorporated herein by reference in its entirety for all purposes.

### FIELD

This invention relates to item detection and more particularly relates to optical sensor-based item detection and automated listing creation.

### BACKGROUND

When a retail item is returned, it can be difficult and/or time consuming to identify the item to again offer it for sale. Similarly, if unknown items are purchased for resale (e.g., a pallet or other set of excess items, returned items, recovered/unclaimed items, or the like) it can also be difficult and/or time consuming to identify each item and to list them for sale. Further, different online listing channels may have different listing requirements, formats, options, or the like.

### BRIEF SUMMARY

Apparatuses, systems, methods, and computer program products are disclosed for optical sensor based item detection and listing. In one embodiment, an apparatus includes an optical sensor. An apparatus, in some embodiments, includes a processor and/or a memory, the memory storing operations executable by the processor. An operation, in one embodiment, includes processing optical data from an optical sensor to identify an item. An operation, in a further embodiment, includes determining data associated with an identified item. In some embodiments, an operation includes reformatting data to create multiple versions of the data, each of the multiple versions of the data associated with a different listing channel for an identified item.

Methods are disclosed for optical sensor based item detection and listing. In one embodiment, a method includes processing optical data from an optical sensor to identify an item. A method, in some embodiments, includes determining data associated with an identified item. In certain embodiments, a method includes reformatting data to create multiple versions of the data, each of the multiple versions of the data associated with a different listing channel for an identified item.

Computer program products are disclosed for optical sensor based item detection and listing. In some embodiments, a computer program product comprises computer program code stored on a non-transitory computer readable storage medium. Computer program code, in one embodiment, is executable by a processor to perform operations. An operation, in certain embodiment, includes processing optical data from an optical sensor to identify an item. An operation, in a further embodiment, includes determining data associated with an identified item. In one embodiment, an operation includes reformatting data to create multiple versions of the data, each of the multiple versions of the data associated with a different listing channel for an identified item.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for item detection and listing;

FIG. 2 is a schematic flow chart diagram illustrating one embodiment of a method for item detection and listing;

FIG. 3 is a schematic flow chart diagram illustrating a further embodiment of a method for item detection and listing; and

FIG. 4 is a schematic flow chart diagram illustrating a certain embodiment of a method for item detection and listing.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

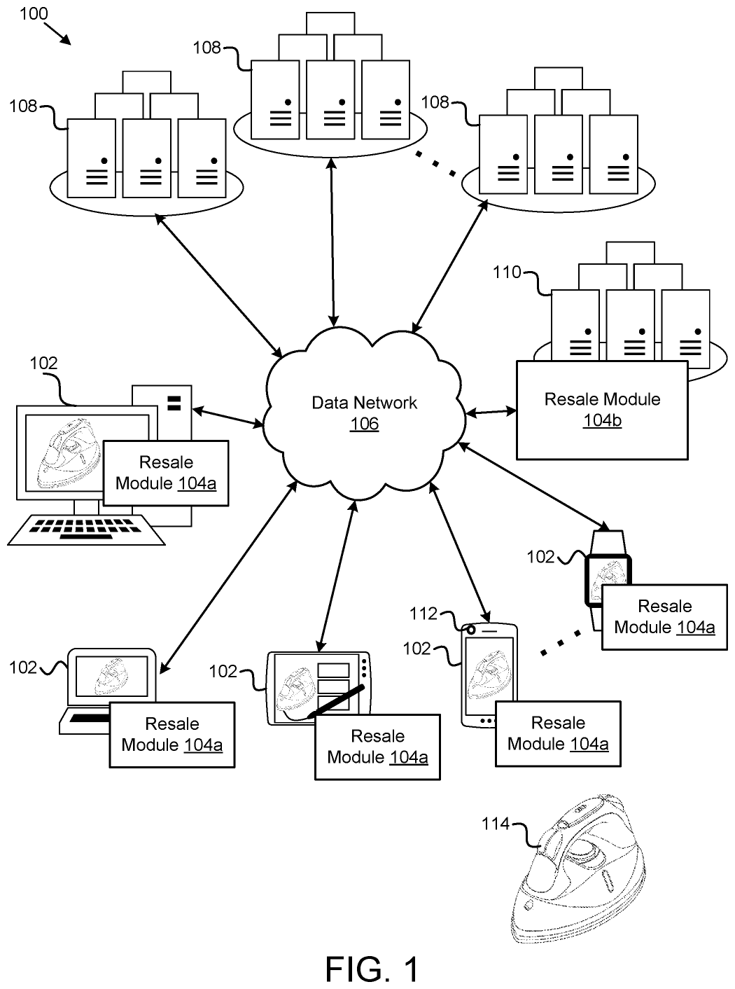

FIG. 1 depicts one embodiment of a system 100 for item detection and listing. In one embodiment, the system 100 includes one or more hardware devices 102 comprising and/or in communication with an optical sensor 112, one or more resale modules 104 (e.g., a backend resale module 104b and/or a plurality of resale modules 104a disposed on the one or more hardware devices 102), one or more data networks 106 or other communication channels, one or more third party service providers 108 (e.g., one or more servers 108 of one or more service providers 108, one or more cloud or network service providers 108, or the like), and/or one or more backend hardware servers 110. In certain embodiments, even though a specific number of hardware devices 102, resale modules 104, data networks 106, third party service providers 108, and/or backend hardware servers 110 are depicted in FIG. 1, one of skill in the art will recognize, in light of this disclosure, that any number of hardware devices 102, resale modules 104, data networks 106, third party service providers 108, and/or backend hardware servers 110 may be included in the system 100 for item detection and listing.

In general, a resale module 104 may automatically and/or programmatically identify an item 114, determine listing data or other descriptive data for the item 114, reformat the data into multiple versions based on requirements of different listing channels, and/or create listings for the item 114 in the different listing channels using the different versions of the data. In certain embodiments, a resale module 104 is configured to process optical data (e.g., a photo or other image, a video, a scan, or the like) from an optical sensor 112 to identify an item 114, such as a retail item 114 for sale or resale, a reclaimed and/or lost item 114, or the like. For example, a resale module 104 may process optical data to locate a barcode, quick response (QR) code, name, and/or other identifier to identify an item 114, may use machine learning and/or other artificial intelligence image processing and/or image recognition to identify an item 114, or the like. Identifying an item 114 may comprise determining an item 114's name, a stock keeping unit (SKU) identifier, a universal product code (UPC), an international article number (EAN), a global trade item number (GTIN), and/or another identifier for the item 114.

In certain embodiments, a resale module 104 may comprise one or more machine learning models (e.g., for image recognition and/or classification, object detection, text and/or image generation, or the like) trained on images, specifications, descriptions, and/or other data associated with different items 114 (e.g., a collection, catalog, and/or other set of potential items 114 for sale; hundreds, thousands, millions, or more items 114; and/or other data). For example, a resale module 104 may use a convolutional neural network, a deep learning model, a single-label classification model, a multi-label classification model, an image segmentation model, an object detection model, a support vector machine model, a scale-invariant feature transform model, a maximally stable extremal regions model, a speeded-up robust features model, a histogram of oriented gradients model, a rule-based classification model, a region-based convolutional neural network, a region proposal network model, a single shot detector model, a K-means clustering model, an iterative self-organizing data analysis technique model, a maximum likelihood model, a minimum distance model, a residual network model, and/or another machine learning model configured to process optical data from an optical sensor 112 to identify an item 114.

A resale module 104, in some embodiments, may be configured to determine data associated with an identified item 114. For example, a resale module 104 may determine an identifier, listing data, a name and/or title, a written description, a specification (e.g., a measurement, a weight, a height, a width, a depth, a feature, a color, a version, a capability, a compatibility, or the like), a photo or other image, a video, a price, and/or other data associated with an item 114. A resale module 104, in one embodiment, may lookup and/or otherwise determine data associated with an identified item 114 based on an identifier for the item 114 (e.g., a name, a title, a SKU, a UPC, an EAN, a GTIN, or the like).

A resale module 104 may query a database or other data store for data associated with an item 114, may crawl one or more websites or other online locations (e.g., a retail website, a wiki or other online data repository, a manufacturer's website, a mobile application, or the like) to download data associated with an item 114, may process data from an optical sensor 112 to determine data associated with an item 114 (e.g., measuring the item 114, determining a color and/or other feature of the item 114, or the like), may prompt a user through a user interface of a computing device 102 to provide data associated with an item 114, and/or may otherwise determine data associated with an item 114. A resale module 104 may determine a category and/or classification for an identified item 114 in a taxonomy of items, or the like and may determine data associated with the item 114 based on the determined category and/or classification.

A resale module 104, in one embodiment, may provide a user interface for a user to define a custom ruleset for setting prices for identified items 114 (e.g., based on manufacturer suggested retail prices (MSRP) determined for an identified item 114, based on one or more attributes or other data determined for an identified item 114, based on a condition of an identified item 114 determined from optical data, or the like). For example, a custom ruleset may comprise multiple ranges of MSRPs or other determined data, mapped to sale prices for each range, or the like. A resale module 104 may determine a sale price for an identified item 114 based on the custom ruleset. In one embodiment, in response to a resale module 104 failing to determine an MSRP for an identified item 114, the resale module 104 may set a sale price for the item 114 based on an average (e.g., a mean, a mode, or the like) of one or more other items 114 (e.g., from a manifest or other group of multiple items 114).

In some embodiments, a resale module 104 may use a generative artificial intelligence (AI) model and/or another machine learning model to determine data associated with an identified item 114. For example, a resale module 104 may use a generative AI model (e.g., a large language model, a transformer-based deep neural network, a deep generative model, a variational autoencoder, a generative adversarial network, a multimodal model, an auto-regressive model, a gaussian mixture model, a hidden Markov model, a probabilistic context-free grammar model, a Bayesian network, an averaged one-dependence estimator, a latent Dirichlet allocation model, a Boltzmann machine model, a generative analysis model, a flow-based generative model, an energy based model, a diffusion model, a K-nearest neighbors model, a logistic regression model, a support vector machine model, a decision tree model, a random forest model, a maximum-entropy Markov model, a conditional random fields model, and/or another machine learning model) to generate and/or otherwise determine data associated with an identified item 114, such as a written description of the item 114, one or more generated images of the item 114 (e.g., an optical sensor 112 may take an image of one view of an item 114 and the resale module 104 may use generative AI to create one or more additional views, angles, or the like of the item 114), or the like.

In certain embodiments, a resale module 104 may process optical data from an optical sensor 112 to identify a plurality of items 114 (e.g., a pallet of items 114, a bundled lot of multiple items 114, or the like). For example, a user and/or a resale module 104 may use an optical sensor 112 to scan and/or otherwise take photos and/or videos of each of a plurality of items 114 individually for the resale module 104 to process (e.g., removing each item 114 from a pallet, box, and/or other group packaging). In some embodiments, a resale module 104 may identify multiple items 114 from a single photo and/or video (e.g., optical data) from an optical sensor 112. For example, a user and/or a resale module 104 may use an optical sensor 112 to scan and/or otherwise take photos and/or videos of each visible side of a pallet, an open box, and/or other group packaging and the resale module 104 may process the resulting photos and/or videos (e.g., optical data) to identify a plurality of items 114.

A resale module 104, in one embodiment, may be configured to predict, extrapolate, and/or otherwise estimate a total number, cost, retail price, sale price, or the like for an entire pallet, box, and/or other group package of multiple items 114 (e.g., with some items 114 not visible in optical data from an optical sensor 112) based on one or more items 114 that the resale module 104 can identify in the optical data. For example, a resale module 104 may process optical data comprising one or more photos and/or videos of one or more visible sides of a pallet, box, and/or other group packaging of multiple items 114 to identify one or more items 114, and may predict, extrapolate, and/or otherwise estimate how many other items 114, what types of items 114, or the like may not be visible based on the optical data.

A resale module 104, in some embodiments, may be configured to automatically populate a manifest (e.g., a list or other data structure) with a plurality of identified items 114 (e.g., with names, serial numbers, and/or other identifiers for the plurality of identified items 114). In a further embodiment, a resale module 104 may be configured to generate and/or otherwise determine data (e.g., a written description, a retail price, a sale price, a listing, one or more photos and/or videos, or the like) for an entire manifest of multiple items 114 based on processed optical data from an optical sensor 112 (e.g., using a machine learning model, or the like).

A resale module 104, in some embodiments, may be configured to display data associated with an identified item 114, with a determined manifest of multiple items 114, or the like to a user on an electronic display screen for a hardware computing device 102 (e.g., for confirmation, as a summary, as a status update, or the like). A resale module 104 may receive user input (e.g., one or more clicks, button and/or key presses, touch input, or the like) from a hardware computing device 102 confirming an identity of a displayed item 114. For example, a graphical user interface of a resale module 104 may allow a user to quickly confirm or deny determined identities of items 114 identified by the resale module 104, without requiring the user to manually lookup or enter identities or other data for the items 114. In response to a user denying a determined identity for an item 114, in some embodiments, a resale module 104 may be configured to reprocess the item 114 to reidentify the item 114 (e.g., to determine a different identity for the item 114), and the resale module 104 may display the different identity to the user on an electronic display screen for a hardware computing device 102 (e.g., for user confirmation of the different identity, or the like).

A resale module 104, in one embodiment, may format and/or reformat data determined for an identified item 114 to create multiple versions of the data for different listing channels for the identified item 114 (e.g., different retail outlets, different websites, different platforms, different entities, different sales types such as auctions and/or fixed price sales, or the like). For example, different listing channels may have different requirements, options, features, capabilities, and/or other differences, such as different character limits for similar text fields (e.g., allowing different lengths of names/titles, descriptions, or the like), different numbers of images allowed, different image size and/or resolution requirements, different data fields or other data requirements, and/or may have other differences. A resale module 104 may comprise a ruleset defining the different requirements of the different listing channels and may use the ruleset to format and/or reformat the determined data to create different versions of the data for the different listing channels. A resale module 104 may further be configured to reformat a written description and/or other determined data for an entire manifest of multiple items 114 to create multiple versions for different listing channels (e.g., based on different requirements for the different listing channels, or the like).

A resale module 104 may use different versions of data associated with an identified item 114 to create listings for the identified item 114 in different listing channels. For example, a resale module 104 may post listings for an item 114 on a retail website 110 associated with the resale module 104 (e.g., a first party website 110 or the like), on one or more retail platforms 108 and/or partners 108 (e.g., a third party website 108 or the like), and/or other locations.

A resale module 104, in certain embodiments, may determine a physical location for an identified item 114 (e.g., a bin, an aisle, a shelf, a warehouse or other building, an address, a geographic location, or the like) and may record the physical location for storing the item 114 in a database and/or other data structure. A resale module 104 may provide the determined location for an identified item 114 to a user (e.g., to fulfill an order for and/or other purchase of the item 114, to locate the item 114, or the like). In a further embodiment, the system 100 may include one or more robotic and/or other automated devices (e.g., robotic arms, conveyer belts, unmanned drones, or the like) configured to automatically place an item 114 in view of an optical sensor 112 in order for a resale module 104 to identify the item 114 and/or to automatically store an identified item 114 at a determined physical location.

A resale module 104, in some embodiments, may be configured to print a tag or label for an identified item 114 (e.g., comprising a price, an identifier such as a name and/or barcode, and/or other data determined for an identified item 114). A resale module 104 may scan the printed tag or label (e.g., affixed to an identified item 114) as the identified item 114 is stored, as the identified item 114 is sold, and/or in response to another event for the identified item 114. For example, a resale module 104 may track an inventory of a plurality of identified items 114 in a database, a point of sale system, or the like, using printed tags and/or labels, and may track individual items 114 to the original pallet, box, load, source, and/or other group of multiple items 114 from which the individual item 114 was originally received.

In one embodiment, the system 100 includes one or more hardware devices 102. The hardware devices 102 (e.g., scanner devices, computing devices, information handling devices, or the like) may include one or more of a desktop computer, a laptop computer, a mobile device, a tablet computer, a smart phone, a smart watch, an optical head-mounted display (e.g., a virtual reality headset, smart glasses, or the like), a personal digital assistant, a hardware scanning device (e.g., for scanning barcodes, QR codes, or the like), and/or another computing device comprising a processor (e.g., a central processing unit (CPU), a processor core, a field programmable gate array (FPGA) or other programmable logic, an application specific integrated circuit (ASIC), a controller, a microcontroller, and/or another semiconductor integrated circuit device), a volatile memory, and/or a non-volatile storage medium. In certain embodiments, the hardware devices 102 are in communication with one or more servers 108 of one or more third party service providers 108 and/or one or more backend hardware servers 110 via a data network 106, described below. One or more hardware devices 102, in a further embodiment, may be capable of executing various programs, program code, applications, instructions, functions, or the like.

A hardware device 102, in certain embodiments, comprises and/or is in communication with (e.g., over a data network 106 and/or another wired or wireless communications channel) an optical sensor 112. An optical sensor 112, in various embodiments, may comprise a camera, a radar, a lidar, an infrared sensor, a wavelength meter, a radiometer, a photodiode, a charge-coupled device (CCD), a CMOS image sensor, or the like. An optical sensor 112, in some embodiments, may be integrated with a hardware computing device 102. In a further embodiment, an optical sensor 112 may be in communication with a hardware computing device 102 over a data network 106 and/or another wired or wireless connection.

In one embodiment, a resale module 104 is configured to access a server 108 of a third party service provider 108 (e.g., over a data network 106 or the like) to download data associated with an identified item 114. A resale module 104, in various embodiments, may provide the downloaded data to a user locally (e.g., displaying the data on an electronic display of a hardware device 102); may provide the downloaded data from the hardware device 102 to a remote server 110 (e.g., a backend resale module 104b) which may be unaffiliated with the third party service provider 108; may provide one or more alerts, messages, or other communications to the user (e.g., on a hardware device 102) based on the downloaded data; or the like.

In various embodiments, a resale module 104 may be embodied as hardware, software, or some combination of hardware and software. In one embodiment, a resale module 104 may comprise executable program code stored on a non-transitory computer readable storage medium for execution on a processor of a hardware device 102, a backend hardware server 110, or the like. For example, a resale module 104 may be embodied as executable program code executing on one or more of a hardware device 102, a backend hardware server 110, a combination of one or more of the foregoing, or the like. In such an embodiment, the various modules that perform the operations of a resale module 104, may be located on a hardware device 102, a backend hardware server 110, a combination of the two, and/or the like.

In various embodiments, a resale module 104 may be embodied as a hardware appliance that can be installed or deployed on a backend hardware server 110, on a user's hardware device 102 (e.g., a dongle, a protective case for a phone 102 or tablet 102 that includes one or more semiconductor integrated circuit devices within the case in communication with the phone 102 or tablet 102 wirelessly and/or over a data port such as USB or a proprietary communications port, a handheld scanner device 102, and/or another peripheral device), or elsewhere on the data network 106 and/or collocated with a user's hardware device 102. In certain embodiments, a resale module 104 may comprise a hardware device such as a secure hardware dongle or other hardware appliance device (e.g., a network appliance, or the like) that attaches to another hardware device 102, such as a laptop computer, a server, a tablet computer, a smart phone, or the like, either by a wired connection (e.g., a USB connection) or a wireless connection (e.g., Bluetooth®, Wi-Fi®, near-field communication (NFC), or the like); that attaches to an electronic display device (e.g., a television or monitor using an HDMI port, a DisplayPort port, a Mini DisplayPort port, VGA port, DVI port, or the like); that operates substantially independently on a data network 106; or the like. A hardware appliance of a resale module 104 may comprise a power interface, a wired and/or wireless network interface, a graphical interface (e.g., a graphics card and/or GPU with one or more display ports) that outputs to a display device, and/or a semiconductor integrated circuit device as described below, configured to perform the functions described herein with regard to a resale module 104.

A resale module 104, in such an embodiment, may comprise a semiconductor integrated circuit device (e.g., one or more chips, die, or other discrete logic hardware), or the like, such as a field-programmable gate array (FPGA) or other programmable logic, firmware for an FPGA or other programmable logic, microcode for execution on a microcontroller, an application-specific integrated circuit (ASIC), a processor, a processor core, or the like. In one embodiment, a resale module 104 may be mounted on a printed circuit board with one or more electrical lines or connections (e.g., to volatile memory, a non-volatile storage medium, a network interface, a peripheral device, a graphical/display interface. The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of a resale module 104.

The semiconductor integrated circuit device or other hardware appliance of a resale module 104, in certain embodiments, comprises and/or is communicatively coupled to one or more volatile memory media, which may include but is not limited to: random access memory (RAM), dynamic RAM (DRAM), cache, or the like. In one embodiment, the semiconductor integrated circuit device or other hardware appliance of a resale module 104 comprises and/or is communicatively coupled to one or more non-volatile memory media, which may include but is not limited to: NAND flash memory, NOR flash memory, nano random access memory (nano RAM or NRAM), nanocrystal wire-based memory, silicon-oxide based sub-10 nanometer process memory, graphene memory, Silicon-Oxide-Nitride-Oxide-Silicon (SONOS), resistive RAM (RRAM), programmable metallization cell (PMC), conductive-bridging RAM (CBRAM), magneto-resistive RAM (MRAM), dynamic RAM (DRAM), phase change RAM (PRAM or PCM), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (NFC) network, an ad hoc network, and/or the like. The data network 106 may include a wide area network (WAN), a storage area network (SAN), a local area network (LAN), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The one or more third party service providers 108, in one embodiment, may include one or more network accessible computing systems such as one or more web servers hosting one or more web sites, an enterprise intranet system, an application server, an application programming interface (API) server, an authentication server, or the like. The one or more third party service providers 108 may include systems related to various entities such as merchants, retail platforms, service providers, and/or other entities. For example, a third party service provider 108 may include a system providing electronic access to an ecommerce site or other online retailer or service provider, or the like. A third party service provider 108 may allow users and/or a resale module 104 to upload, view, create, post, and/or otherwise list one or more identified items 114 (e.g., for sale, trade, auction, or the like).

In one embodiment, the one or more backend hardware servers 110 and/or one or more backend resale modules 104b provide central management of one or more networked resale modules 104a. For example, the one or more backend resale modules 104b and/or a backend hardware server 110 may store downloaded data associated with items 114 centrally, may provide instructions for the resale modules 104a to access item data from one or more third party service providers 108, or the like. A backend hardware server 110 may include one or more servers 110 located remotely from the hardware devices 102 and/or the one or more third party service providers 108. A backend hardware server 110 may comprise hardware of a resale module 104, may store executable program code of a resale module 104 in one or more non-transitory computer readable storage media, and/or may otherwise perform one or more of the various operations of a resale module 104 described herein.

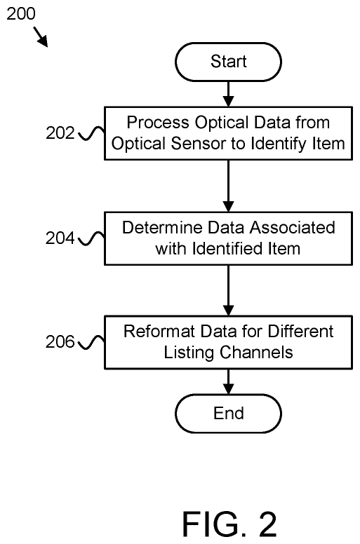

FIG. 2 depicts one embodiment of a method 200 for item detection and listing. The method 200 begins and a resale module 104 processes 202 optical data from an optical sensor 112 to identify an item 114. A resale module 104 determines 204 data associated with the identified item 114. A resale module 104 reformats 206 the data to create multiple versions of the data, each version of the data associated with a different listing channel for the identified item 114 and the method 200 ends.

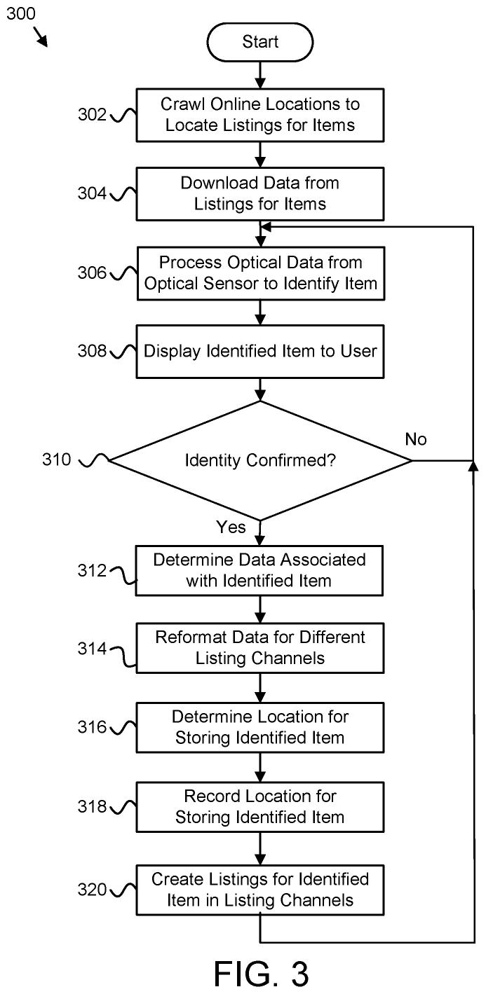

FIG. 3 depicts one embodiment of a method 300 for item detection and listing. The method 300 begins and a resale module 104 crawls 302 one or more online locations 108 to locate one or more listings for items 114. A resale module 104 downloads 304 the data from the located one or more listings for items 114.

A resale module 104 processes 306 optical data from an optical sensor 112 to identify an item 114. A resale module 104 displays 308 a determined identity and/or other data for the identified 306 item to a user on an electronic display screen for a hardware computing device 102. In response to a user denying 310 and/or failing to confirm 310 an identity of the item 114, a resale module 104 reprocesses 306 the optical data to reidentify the item 114 and the method 300 continues.

In response to receiving user input confirming 310 an identity of the item 114, a resale module 104 determines 312 data associated with the identified item 114. A resale module 104 reformats 314 the data to create multiple versions of the data, each version of the data associated with a different listing channel for the identified item 114.

A resale module 104 determines 316 a location for storing the identified item 114. A resale module 104 records 318 the location for storing the identified item 114. A resale module 104 creates 320 a listing for the identified item 114 in each of a plurality of different listing channels based on the multiple versions of the data and the method 300 continues for subsequent items 114.

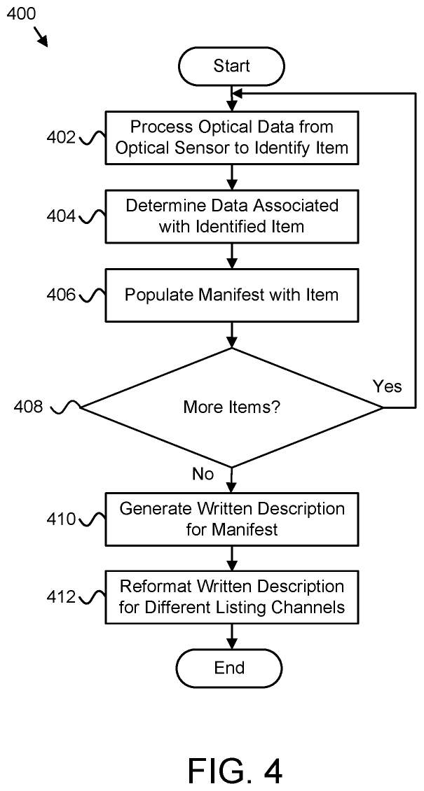

FIG. 4 depicts one embodiment of a method 400 for item detection and listing. The method 400 begins and a resale module 104 processes 402 optical data from an optical sensor 112 to identify one or more items 114 (e.g., a first item 114, one or more additional items 114, or the like). A resale module 104 determines 204 data associated with the identified item 114. A resale module 104 automatically populates 406 a manifest with the item 114. A resale module 104 determines 408 whether or not there are any additional items 114 for the manifest.

In response to a resale module 104 determining 408 that there are one or more additional items 114 for the manifest, the resale module 104 processes 402 additional optical data from an optical sensor 112 to identify the one or more additional items 114 and the method 400 continues. In response to a resale module 104 determining 408 that there are no additional items 114 for the manifest, the resale module 104 generates 410 (e.g., using machine learning or other artificial intelligence) a written description for the manifest based on the identified 402 items 114. A resale module 104 reformats 412 the written description to create multiple versions of the written description (e.g., each associated with different listing channels, or the like) and the method 400 ends.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
an optical sensor;
a processor; and
a memory storing operations executable by the processor, the operations comprising:
processing optical data from the optical sensor to identify an item;
determining data associated with the identified item; and
reformatting the data to create multiple versions of the data, each of the multiple versions of the data associated with a different listing channel for the identified item.

2. The apparatus of claim 1, wherein the operations further comprise creating a listing for the identified item in each of the different listing channels based on the multiple versions of the data.

3. The apparatus of claim 1, wherein the operations further comprise:
processing additional optical data from the optical sensor to identify one or more additional items;
determining data associated with the one or more additional items; and
automatically populating a manifest with the item and the one or more additional items.

4. The apparatus of claim 3, wherein the operations further comprise generating, using machine learning, a written description based on the item and the one or more additional items and associating the written description with the manifest.

5. The apparatus of claim 4, wherein the operations further comprise reformatting the written description to create multiple versions of the written description, each of the multiple versions of the written description associated with a different one of the different listing channels.

6. The apparatus of claim 1, wherein the operations further comprise:
displaying the data associated with the identified item on an electronic display screen for a hardware computing device; and
receiving user input from the hardware computing device confirming an identity of the identified item.

7. The apparatus of claim 1, wherein the optical data comprises a barcode.

8. The apparatus of claim 1, wherein the optical data comprises a quick response code.

9. The apparatus of claim 1, wherein the optical data comprises image data of the item and identifying the item comprises machine learning image processing of the optical data to identify the item.

10. The apparatus of claim 1, wherein determining the data comprises crawling one or more online locations to locate one or more listings for the identified item and downloading the data from the located one or more listings for the identified item.

11. The apparatus of claim 1, wherein the operations further comprise:
determining a location for storing the item; and
recording the location for storing the item.

12. The apparatus of claim 1, wherein the reformatting the data is based on one or more different requirements of the different listing channels.

13. The apparatus of claim 12, wherein the one or more different requirements comprise different character limits for one or more text fields for the different listing channels.

14. A method comprising:
processing optical data from an optical sensor to identify an item;
determining data associated with the identified item; and
reformatting the data to create multiple versions of the data, each of the multiple versions of the data associated with a different listing channel for the identified item.

15. The method of claim 14, further comprising creating a listing for the identified item in each of the different listing channels based on the multiple versions of the data.

16. The method of claim 14, further comprising:
processing additional optical data from the optical sensor to identify one or more additional items;
determining data associated with the one or more additional items; and
automatically populating a manifest with the item and the one or more additional items.

17. The method of claim 16, further comprising generating, using machine learning, a written description based on the item and the one or more additional items and associating the written description with the manifest.

18. The method of claim 17, further comprising reformatting the written description to create multiple versions of the written description, each of the multiple versions of the written description associated with a different one of the different listing channels.

19. The method of claim 14, further comprising:
displaying the data associated with the identified item on an electronic display screen for a hardware computing device; and
receiving user input confirming an identity of the identified item.

20. A computer program product comprising computer program code stored on a non-transitory computer readable storage medium, the computer program code executable by a processor to perform operations comprising:
processing optical data from an optical sensor to identify an item;
determining data associated with the identified item; and
reformatting the data to create multiple versions of the data, each of the multiple versions of the data associated with a different listing channel for the identified item.
